(19) United States
(12) Patent Application Publication
(10) Pub. No.: US 2017/0008220 A1
(43) Pub. Date: Jan. 12, 2017

(54) METHOD FOR EMBOSSING A FABRIC PRODUCT WHILE THE PRODUCT IS SITUATED IN PACKAGING

(71) Applicant: AREA STUDIO, LLC, New York, NY (US)

(72) Inventors: Elizabeth Beckett FOGG, New York, NY (US); Iwo Piotr PANSCZCYK, New York, NY (US)

(21) Appl. No.: 14/796,455

(22) Filed: Jul. 10, 2015

(51) Int. Cl. B29C 59/02; B65B 51/10; B29C 59/00

(52) U.S. Cl. CPC B29C 59/026; B29C 59/007; B65B 51/10; B29L 2031/4842

(57) ABSTRACT

A product including a fabric layer is situated in a plastic bag such that at least a part of the fabric layer is aligned with a portion of a plastic sheet of the bag. An embossing tool is used to press the product and impress the embossing pattern into the fabric product, through the plastic sheet, as well as in the plastic sheet itself, at the same time. Perforations may be created by the embossing tool in certain sections of the product, such as the non-folded sections, and not in other sections. The perforations become an array of holes to create a mesh-like affect by stretching the fabric as the product is removed stretched from the package, used and washed. The tool also presses the plastic sheets together to seal the product in the package.

### BACKGROUND OF THE INVENTION

1. Field of the Invention

The present invention relates to a method of embossed a design in a fabric product of the type which is sold in a package such as a plastic bag, and more particularly to a method of creating an embossed design in a fabric product, and in the package in which the fabric product is situated, while the product is situated in a plastic package, at the same time.

2. Description of Prior Art Including Information Disclosed Under 37 CFR 1.97 and 1.98

Embossing fabric sheet material to create designs is well known in the art. Embossing tools in the form of reciprocating plates or rotating rollers with sets of protrusions arranged in specific patterns are commonly used for this purpose. The embossing tool applies pressure on the fabric sheet to cause the protrusions to produce impressions or an array of small holes in the fabric sheet in the desired pattern. If both impressions and a holes array are required to be embossed in the same fabric sheet, separate embossing tools, and hence additional production steps, may be required for each.

The fabric sheets may be embossed before or after the sheets are formed into a finished product. Typically, the finished product, such as an article of clothing, is then folded and the folded product is placed in a plastic bag. The plastic bag is then sealed and shipped to a retailor for resale or directly to the customer.

If the fabric sheet could be embossed in a manner that would allow the same embossing tool to produce both impressions and an array of holes in the fabric sheet at the same time, the number of production steps necessary to produce the finished product, and hence the cost of manufacturing the finished product, would be reduced.

Moreover, if the finished product could be folded and placed in the plastic package before embossing takes place, the package itself could be provided with the embossed design as well as the product. The package would then also have an aesthetically pleasing design. Further, the package could be sealed as a result of the embossing, without the necessity of an additional processing step. The result would be that the finished fabric product would be embossed and packaged more efficiently and at less cost. Further, the package would also have an attractive design.

It is therefore a prime object of the present invention to provide a method of embossing a fabric product while the product is situated in packaging.

It is another object of the present invention to provide a method of embossing a fabric product while the product is situated in packaging in which the product and the package are embossed at the same time, in the same process step.

It is another object of the present invention to provide a method of embossing a fabric product while the product is situated in packaging in which both impressed sections of the product and perforated sections of the product can be formed at the same time, in the same process step.

It is another object of the present invention to provide a method of embossing a fabric product while the product is situated in packaging in which the fabric product is folded before it is placed in the package and pressed to a compressed state by in the embossing process.

It is another object of the present invention to provide a method of embossing a fabric product while the product is situated in packaging in which the fabric product is embossed to create impressions which through manipulation and stretching of the fabric will create an array of holes in the embossed pattern.

It is another object of the present invention to provide a method of embossing a fabric product while the product is situated in packaging in which the product is pressed to a compressed sate and the package is sealed during the embossing process.

### BRIEF SUMMARY OF THE INVENTION

To those and any additional objects which may herein after appear, the present invention relates to a method of creating an embossed design in a fabric product with an embossing tool having protrusions arranged in an embossing pattern. The method includes the steps of: creating a fabric product including a layer of fabric; creating a package to receive the fabric product including plastic sheet; inserting the fabric product into the packaging such that at least a part of the fabric layer is aligned with at least a portion of the plastic sheet; and using the embossing tool to impress the embossing pattern in the part of the fabric layer aligned with the portion of the plastic sheet, through the aligned portion of the plastic sheet.

The step of using the embossing tool to impress the embossing pattern in the part of the fabric layer includes embossing the pattern in the plastic sheet of the package. Embossing the pattern in the plastic sheet of the packaging takes place at the same time as the embossing pattern is impressed in the part of the fabric layer.

The step of using the embossing tool includes the step of creating perforations in the embossing pattern in the aligned part of the fabric layer. The term “perforations” as it is used herein means creating impressions which form very thin layers of materials under the protrusions in the embossing plate such that through manipulation of the fabric material by removing the product from the package, use of the product or washing of the product, holes are created in the material in the desired embossing pattern.

The method also includes the step of impressing the embossing pattern in the plastic sheet at the same time and in the same process step as creating the impressions in the product.

The perforations are formed at the same time as the embossing pattern is impressed in the plastic sheet. The perforations are created in the fabric layer and in the aligned portion of the plastic sheet by protrusions in the embossing tool which reduces the thickness of the materials under the protrusions to the point where holes are formed as a result of manipulation of the product by removal from the package, use, washing or the like activities wherein the fabric is stretched.

The part of the fabric layer aligned with the portion of the plastic sheet includes first and second sections. The step of creating perforations includes the step of creating perforations in one of the sections but not in the other of the sections.

The step of using the embossing tool to impress the embossing pattern includes using the embossing tool to press the fabric layer to a compressed state.

The package includes first and second plastic sheets of a given size. The fabric layer is received between the plastic sheets. The fabric product is smaller than the size of the plastic sheets which form the package such that at least a portion of the plastic sheets are adjacent to each other, usually in the area surrounding the product. The step of using the embossing tool to impress the embossing pattern includes pressing the plastic sheets together in those areas such that the adjacent portions of the plastic sheets are sealed to each other.

The method further includes the step of folding the layer of fabric to create a folded fabric section and a non-folded fabric section of the fabric product. The perforations are created in the non-folded fabric section of the fabric product.

The folded fabric section of the fabric product includes a top fabric layer and a bottom fabric layer. The perforations are created in the top fabric layer of the folded fabric section.

The step of creating the package includes creating first and second sheets of plastic, aligning the plastic sheets in face-to-face relation, and sealing the plastic sheets together to form a bag with an opening.

The step of using the embossing tool to impress the embossing pattern includes using the embossing tool to impress the embossing pattern into the first plastic sheet.

The step of using the embossing tool to impress the embossing pattern includes using the embossing tool to impress the embossing pattern into the first plastic sheet and into the second plastic sheet at the same time.

The plastic sheet comprises polypropylene. The plastic sheet preferably includes polypropylene homopolymer.

The embossing tool may be a reciprocating plate or a rotating roller.

The embossing tool may be heated.

### BRIEF DESCRIPTION OF THE SEVERAL VIEWS OF DRAWINGS

To these and to such other objects that may hereinafter appears, the present invention relates to a method for embossing a fabric product while the product is situated in packaging as described in detail in the following specification and recited in the annexed claims, taken together with the accompanying drawings, in which like numerals refer to like parts and in which:

FIG. 1 is an elevation view of a fabric T-shirt product;

FIG. 2 is an elevation view of a plastic bag in which the T-shirt product of FIG. 1 is packaged;

FIG. 3 is an elevation view of the T-shirt of FIG. 1 after the T-shirt is folded to form a folded fabric portion and a non-folded fabric portion;

FIG. 4 is an elevation view showing the folded fabric product of FIG. 3 spread out and received in the plastic bag package of FIG. 2;

FIG. 5 is a top view of the folded fabric product received in the plastic bag package;

FIG. 6 is a schematic view showing an embossing tool in the form of a reciprocating embossing plate acting on the packaged T-shirt of FIG. 5;

FIG. 7 is a schematic view showing an embossing tool in the form of a rotating roller acting on the packaged T-shirt of FIG. 5;

FIG. 8 is a cross-sectional view of the packaged T-shirt of FIG. 4 as it is being embossed;

FIG. 9 is an enlarged view of the non-folded sleeve section of the packaged T-shirt of FIG. 8 showing the non-folded sleeve section being perforated;

FIG. 10 is an enlarged view of the folded sleeve section of the packaged T-shirt of FIG. 8 showing the folded body section of the T-shirt being embossed;

FIG. 11 is an enlarged view of the folded sleeve section of the packaged T-shirt of FIG. 8 showing the top layer of the folded body section of the T-shirt being perforated;

FIG. 12 is a front elevation view of the exterior of the embossed package t showing the pattern embossed into the top sheet of the package;

FIG. 13 is a rear elevation view of the exterior embossed package showing the pattern embossed into the bottom sheet of the package;

FIG. 14 is an elevation view of the T-shirt product after it has been removed from the package showing the embossed body section and the perforated sleeve sections; and

FIG. 15 is an enlarged cross-sectional view of the T-shirt product showing a portion of the section with impressions and the section with perforations.

### DETAILED DESCRIPTION OF THE INVENTION

The method of the present invention can be used on any product made of fabric which is embossed and is packaged in a plastic bag or other container including a thin sheet of plastic, paper or the like. Although the materials from which the package can be formed of other materials, the package material is referred to as “plastic” herein because that is the most common material used for this purpose.

The method of the present invention is particularly useful for articles of apparel, such as T-shirts and the like, which are made of relatively thin fabric and fabricated to have at least a portion with a surface pattern, texture and/or an array of holes.

The fabric product can be formed of various fabric materials such as 100% cotton, blends of cotton, polyester, viscose, cupro, rayon, nylon, wool, silk, and elastin. The fabrics can be provided in a wide range of styles and weights.

After the fabric product is produced, it can be folded before being placed in a package for embossing. It is preferable to iron the folded fabric product without creases in the fold lines prior to placing the product into its packaging. Different folding methods can be employed, depending on the pattern, fabric content and weight of the fabric. The way the fabric product is folded dictates where the fold lines, impressions and perforations will be situated.

The packaging in which the fabric product is situated is preferably a clear, flat plastic bag. The bag can be made of thin sheets of polypropylene, cellophane or similar plastic material. The plastic sheets are heat seal along the edges and bottom to form a recess with an open top into which the fabric product is inserted.

The dimensions of the bag are determined by the size of the fabric product after it is folded. Preferably, the size of the bag is chosen such that is larger than the folded fabric pattern such that the plastic sheets are adjacent to each other in face-to-face relation in the areas surrounding the fabric product such that the plastic sheets are sealed together in the areas surrounding the product and seal the product in the package as a result of the embossing processes.

After embossing, the bags can be cut down to a custom size, if desired. For example, the plastic bag could be cut in the shape of the folded fabric product.

The embossing process is performed by an embossing tool. It is often desirable to heat the embossing tool during the process. Polypropylene or cellophane bags are preferred because they have a higher melting point, as compared to other plastic sheet materials.

The most preferred bag composition is 95% virgin polypropylene homopolymer and 5% stabilizers. Bags made of that material are sulfur, amide, amine, silicone, BHT and latex free, and can be recycled. However, bags of different material/content can be used successfully, depending on the amount of pressure applied and the temperature of the embossing tool used in the embossing process.

Once the fabric product has been folded and placed in its plastic bag packaging, the packaged product is ready to be embossed. Different types of embossing equipment can be used, including hydraulic and electrically driven reciprocating embossing plates, and rotating embossing rollers, which apply pressure on the packaged fabric product as the impressions are formed. Heat may or may not be employed in the process—depending on the equipment used and the effect which is desired.

The packaged fabric product is placed on a work surface under the embossing tool, and pressed by the embossing tool for an allotted amount of time, until the combination of pressure and heat (if present) has imparted the impressions and perforations in both the fabric product and the sheets of the plastic bag packaging. The arrangement, size and shape of the protrusions which form part of the embossing tool will determine the pattern which is created.

Heating the embossing tool may cause the adjacent portions of the plastic sheets which form the bag to meld together and seal the fabric product within the packaging. The thickness and composition of the fabric from which the product is made, the folding method, the amount of heat employed, and the amount of pressure applied by the embossing tool are all factors which determine the intensity of the design, as well as the size and location of the impressions and perforations and the sealed areas.

In order to open the embossed package in which the fabric product is sealed, the plastic sheets of the bag which have been pressed together during the embossing process are peeled apart, exposing the fabric product such that it can be removed. Although the plastic sheets of bag may have been melded together in the embossing process, the plastic sheets of the bag will not stick to or melt into the fabric product itself, except in the areas which are perforated.

In the perforated areas, the plastic sheets of the bag will initially stick to the fabric product. As the plastic sheets of the bag are separated and the fabric product is removed, the perforated areas of the product are exposed. As the product is manipulated and unfolded, the process of pulling apart the layers of the product will enlarge some of the perforations to create a pattern of holes in the fabric product. Accordingly, some of the perforations will transform into holes as a result of removing the product from the packaging. This is a desired effect.

Throughout the embossing process, the fabric product will become more structured and stiff. The remaining holes in the perforated areas will open as the fabric product is stretched through use over time and repeatedly washed. This affect can be expedited or exaggerated by hand stretching or by aggressive washing techniques. In either case, the perforated areas will eventually morph into an array of holes with a mesh-like texture.

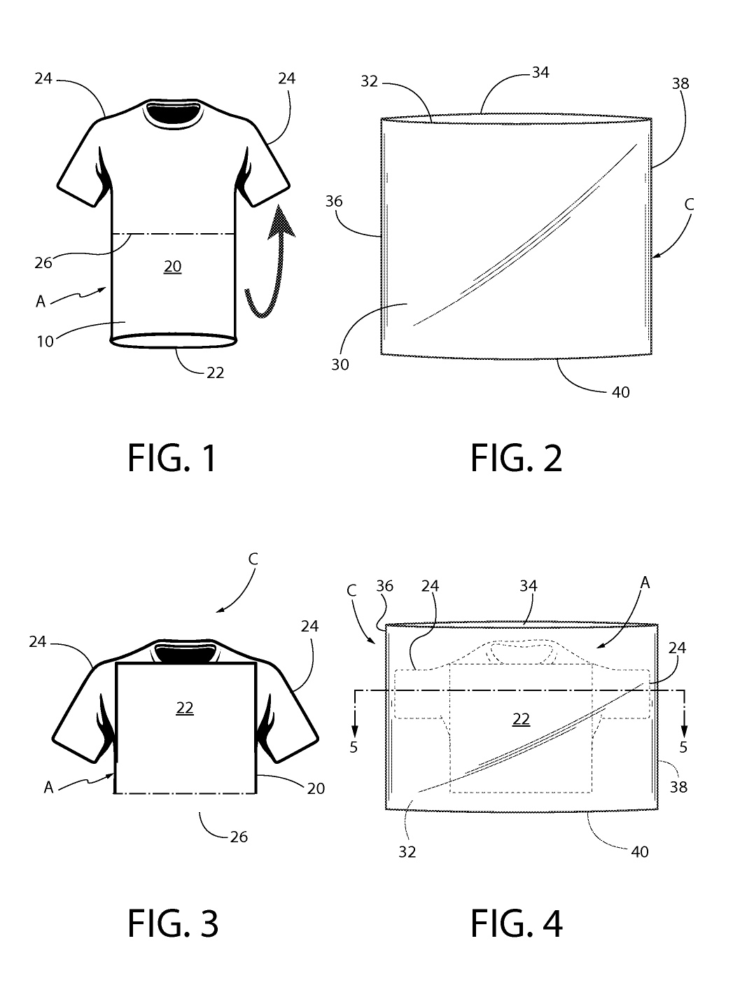

FIG. 1 illustrates an example of a typical fabric product, generally designated A, such as a T-shirt which could he used in the method of the present invention. It should be understood while the method of the present invention is illustrated with a T-shirt 10, as an example, the invention should not be considered to be limited to that or any other particular product. Instead, the invention may be employed with any fabric product suitable for packaging in a plastic bag and which is to be embossed.

In its broadest sense, the method of the present invention creates an embossed design in a packaged fabric product, generally designated A, such as T-shirt 10, using an embossing tool, generally designated B, which may take the form of a reciprocating plate 12 or a rotating roller 14. The surface of plate 12 or roller 14 may be heated using electrically energized resistance wires, heated liquid, or any other method, as is conventional.

The surface of tool B is provided with a plurality of protrusions or teeth 16 which extend outwardly from the surface. Protrusions 16 are arranged in the desired embossing pattern. The tips of the protrusions are provided with a distinct cross-sectional shape selected to create impressions of the desired shape and size. The protrusions will create relatively well defined rounded impressions in the front sheet of the plastic bag package. The impressions in the rear sheet of the plastic bag package will be less defined because of the layers of material which the protrusions must pass through.

FIG. 1 illustrates a conventional T-shirt 10 made of thin cotton material. T-shirt 10 includes a front body portion 20, a back body portion 22 and oppositely directed short sleeves 24.

FIG. 2 illustrates a package, generally designated C, in the form of a plastic bag 30, suitable for packaging the T-shirt. Package C includes a top sheet 32 which will become the front of the package, a bottom sheet 34 which will become the rear of the package, both made of thin plastic material, such as polypropylene homopolymer. Sheets 32, 34 are so thin so as to be negligible as compared to the thickness of the fabric of the T-shirt. In order to form the bag, sheets 32 and 34 are aligned in face-to-face relation and heat sealed along the edges 36, 38 and bottom 40 to create a recess. The top of the bag is not sealed so as to form an entry opening through which the T-shirt can be inserted into the recess of the formed bag.

As shown in FIG. 3, T-shirt 10 may be folded. In this example, the product is folded along line 26 such that the bottom half overlaps the top half to form a folded body section with the sleeves 24 extending outwardly. The sleeve 24 form non-folded sections of the product. The folded body section of the T-shirt has a top fabric sheet (back body portion 22) and a bottom fabric sheet (front body portion 20 and sleeves 24) and thus is substantially thicker than the non-folded sleeves 24. However the product can be folded in any manner desired to create folded and non-folded sections

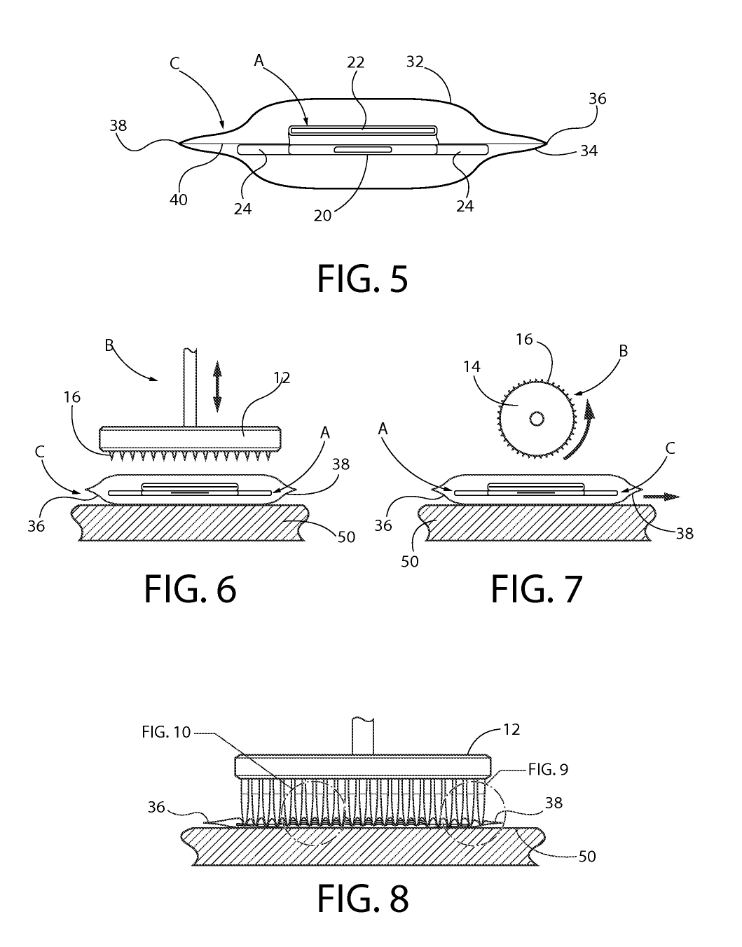

The sleeves of the folded T-shirt are spread out and the T-Shirt is inserted into bag 30, as seen in elevation view in FIG. 4, and in top view in FIG. 5, such that at least a part of the fabric product is aligned with at least a portion of the plastic sheet of the bag. In this example, the entire folded T-shirt is aligned with the sheets of the plastic bag, but that is not necessarily the case.

As seen in FIG. 6, the product and package are embossed by placing the packaged product on a work surface 50 beneath embossing plate 12. The plate is moved toward surface 50 such that the protrusions 16 extending from the bottom surface of the plate impress the embossing pattern on the packaged product and at the same time apply sufficient pressure on the packaged product to press the product into a compressed state.

FIG. 7 shows an alternative embossing tool in the form of rotatable roller 14 with protrusions 16 extending from the exterior surface thereof. The drawing shows the direction of roller rotation and movement of the packaged product during the embossing process.

The embossing tool B imparts the embossing pattern in at least one plastic sheet of the bag and in the fabric product, through that plastic sheet, as illustrated in FIG. 8. The result is that the embossing pattern is impressed in the fabric product and in the aligned plastic sheets which form the bag, at the same time, with the same tool, in the same operation.

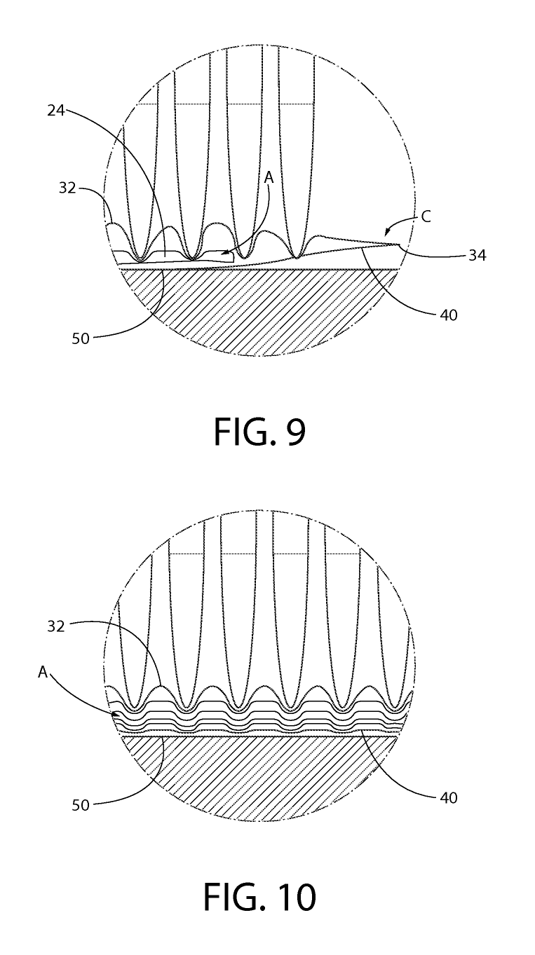

Further, because the non-folded sleeves 24 are thinner than the folded body section of the T-shirt, and the non-folded sleeves are situated on hard work surface 50, the protrusions 16 of the embossing tool aligned with the non-folded sleeve section of the product create impressions in the embossing pattern in the sleeves 24 and in the align portions of plastic sheet 32 of the bag, in which the materials are stretched to create perforations, as seen in FIG. 9. Those perforations will become an array of holes in the sleeves as the T-shirt is stretched as it is removed from the bag, worn and washed, as explained above

At the same time, the protrusions 16 which are aligned with the folded body section of the product will create rounded impressions in the embossing pattern in plastic sheet 32, in the folded body section of the T-shirt, and in the plastic sheet 34. However, impressions will normally not become holes because the layers of the folded body section of the T-shirt form a cushion such that the areas under the protrusions are not reduced in thickness to the point where perforations are created by removal of the product or use of the product.

Further, the protrusions 16 of the embossing tool may be formed to have a length at least as great as the thickness of the non-folded sleeves but not as great as the thickness of the dual layer folded fabric section of the body portion of the T-shirt. As a result, the protrusions can create perforations in the embossed pattern in the front plastic sheet 32 of the bag and in the top fabric layer 22 of the folded body section of the body portion of the T-shirt, while only creating impressions in the bottom fabric layer 20 and plastic sheet 34, as seen in FIG. 11.

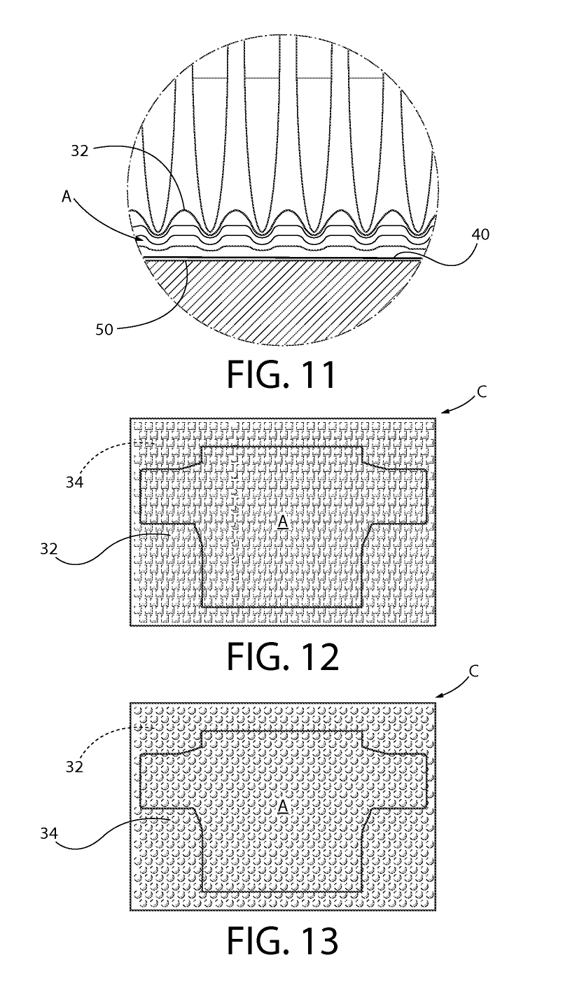

FIG. 12 shows an embossing pattern with relatively sharply defined impressions created by embossing tool B in the front sheet 32 of the plastic bag package. FIG. 13 shows that the embossing pattern formed by embossing tool B in the rear plastic sheet of the bag is formed of relatively less sharply defined, more rounded impressions.

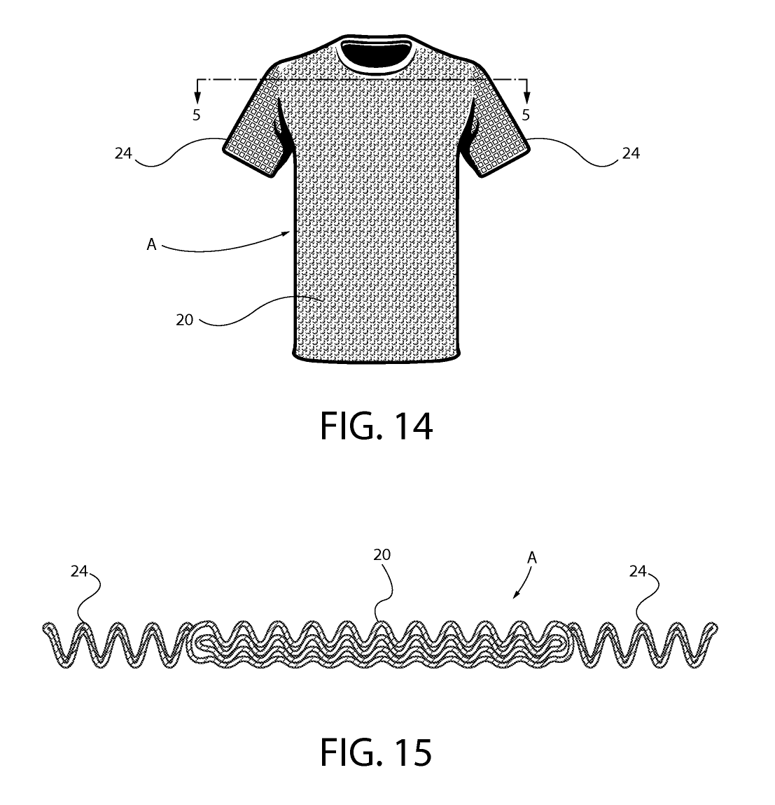

FIG. 14 shows the T-shirt as it would appear after it is removed from the package, with the embossed impressions in the body portion of the T-shirt and perforations which will form holes in the non-folded sleeves of the T-shirt. FIG. 15 shows a impressed section of the product and a perforated section of the product in greater detail.

While only a limited number of preferred embodiments of the present invention have been disclosed for purposes of illustration, it is obvious that many modifications and variations could be made thereto. It is intended to cover all of those modifications and variations which fall within the scope of the present invention, as defined by the following claims.

We claim:

1. A method of creating an embossed design in a fabric product with an embossing tool having a protrusions arranged in an embossing pattern, said method comprising the steps of:
(a) creating a product including a layer of fabric;
(b) creating a package to receive the product including a plastic sheet;
(c) inserting the product into the packaging such that at least a part of the fabric layer is aligned with at least a portion of the plastic sheet; and
(d) using the embossing tool to impress the embossing pattern in the part of the fabric layer aligned with the portion of the plastic sheet, through the aligned portion of the plastic sheet.

2. The method of claim 1 wherein the step of using the embossing tool to impress the embossing pattern in the part of the fabric layer includes the step of impressing the embossing pattern in the plastic sheet.

3. The method of claim 2 wherein the step of using the embossing tool to impress the embossing pattern in the part of the fabric layer includes the step of impressing the embossing pattern in the plastic sheet at the same time as the embossing pattern is impressed in the part of the fabric layer.

4. The method of claim 1 wherein the step of using the embossing tool includes the step of creating perforations in the embossing pattern in the part of the fabric layer aligned with the portion of the plastic sheet.

5. The method of claim 4 wherein the part of the fabric layer aligned with the portion of the plastic sheet includes first and second sections and the step of creating perforations includes the step of creating perforations in one of said sections but not in the other of those sections.

6. The method of claim 1 wherein the step of using the embossing tool to impress the embossing pattern includes using the embossing tool to press the fabric layer into a compressed state.

7. The method of claim 1 wherein the package includes first and second plastic sheets of a given size, wherein said fabric layer is received between said plastic sheets, wherein said fabric layer is smaller than said given size such that at least a portion of the plastic sheets are adjacent to each other and wherein the step the using the embossing tool to impress the embossing pattern includes pressing the plastic sheets together such that said portions of said plastic sheets are sealed to each other.

8. The method of claim 1 further including the step of folding the layer of fabric to create a folded fabric section of the fabric product and a non-folded fabric section.

9. The method of claim 8 wherein the step the using the embossing tool to impress the embossing pattern includes the step of creating perforations in said non-folded fabric section.

10. The method of claim 9 wherein the folded fabric section includes a top fabric layer and a bottom fabric layer and wherein the step of creating perforations in said non-folded fabric section includes creating perforations in said top fabric layer.

11. The method of claim 1 wherein the step of creating the package comprises the steps of creating first and second sheets of plastic, aligning the plastic sheets in face-to-face relation, and sealing the plastic sheets together to form a recess with an opening.

12. The method of claim 11 wherein the step of using the embossing tool to impress the embossing pattern includes using the embossing tool to impress the embossing pattern into the first plastic sheet.

13. The method of claim 11 wherein the step of using the embossing tool to impress the embossing pattern includes using the embossing tool to impress the embossing pattern into the first plastic sheet and the second plastic sheet.

14. The method of claim 1 wherein the plastic sheet comprises polypropylene.

15. The method of claim 1 wherein the plastic sheet comprises polypropylene homopolymer.

16. The method of claim 1 wherein the embossing tool is a reciprocating plate.

17. The method of claim 1 wherein the embossing tool is a rotating roller.

18. The method of claim 1 wherein the embossing tool is heated.
